(19) United States
(12) Patent Application Publication
(10) Pub. No.: US 2026/0133565 A1
(43) Pub. Date: May 14, 2026

(54) AGGREGATION OF EDGE COMPUTING WORKLOADS ON A PROGRAMMABLE LOGIC CONTROLLER (PLC)

(71) Applicant: ROCKWELL AUTOMATION TECHNOLOGIES, INC., MAYFIELD HEIGHTS, OH (US)

(72) Inventors: Joshua C. Seabloom, Upper Arlington, OH (US); Jason Yagielo, Asheville, NC (US); Adam F. Calhoon, Worthington, OH (US); Ryan J. Russell, Hillsboro, OR (US); Sivaram Balasubramanian, Solon, OH (US); Bhanu K. Gouda, Reminderville, OH (US); Diane E. Golden, West Allis, WI (US); Paul C. Whitten, Munson Township, OH (US)

(21) Appl. No.: 19/378,087

(22) Filed: Nov. 3, 2025

Related U.S. Application Data
(60) Provisional application No. 63/720,317, filed on Nov. 14, 2024.

(51) Int. Cl. G05B 19/418; G06F 9/455; H04L 67/10

(52) U.S. Cl. CPC G05B 19/41875; G05B 19/4185; H04L 67/10; G06F 9/455

(57) ABSTRACT

Systems, industrial devices, and methods for aggregating edge workloads of an industrial system. One system includes a programmable logic controller (PLC) of the industrial system. The PLC may receive an edge application to perform an edge workload related to an industrial process of the industrial system. The PLC may store the edge application in a memory local to the PLC, where the edge application may be isolated from control logic that controls execution of the industrial process. The PLC may execute the control logic in order to control performance of the industrial process. The PLC may execute the edge application such that the edge workload is performed locally at the PLC during performance of the industrial process.

### CROSS-REFERENCES TO RELATED APPLICATIONS

This claims priority to U.S. Provisional Application No. 63/720,317, filed Nov. 14, 2024, the entire contents of which is incorporated herein by reference.

### BACKGROUND

This disclosure relates to industrial environments and platforms such as industrial automation systems or manufacturing environments. Industrial manufacturing environments may include computing and mechanical systems configured to implement an industrial process. In industrial automation environments, control systems are used to drive various operations along an industrial line. Control programs are developed by programmers in integrated design applications. The integrated design applications may include programming tools to design control schemes for the industrial manufacturing environments. The control programs are used by control systems like Programmable Logic Controllers (“PLCs”) to drive the industrial assets, devices, and sensors in an industrial process. The integrated design applications communicate with numerous systems within industrial manufacturing environments like PLCs and orchestration systems. Integrated design applications may also communicate with external systems. The numerous communication links may create security vulnerabilities in the integrated design applications.

The discussion above is merely provided for general background information and is not intended to be used as an aid in determining the scope of the claimed subject matter.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some examples, the technology disclosed herein provides an industrial controller of an industrial system. The industrial controller may include a memory. The memory may store control logic that controls performance of an industrial process of the industrial system. The memory may store an edge application that performs a function related to the industrial system. The industrial controller may include a processor coupled to the memory. The processor may be configured to execute the control logic to control performance of the industrial process of the industrial system. The processor may be configured to execute the edge application such that the edge workload is performed locally at the industrial controller.

In some examples, the technology disclosed herein provides a system for aggregating edge workloads of an industrial system. The system may include a programmable logic controller (PLC) of the industrial system. The PLC may be configured to receive, from a remote device, an edge application, where the edge application may perform an edge workload related to an industrial process of the industrial system. The PLC may be configured to store the edge application in a memory local to the PLC, where the edge application may be isolated from control logic that controls execution of the industrial process. The PLC may be configured to execute the control logic in order to control performance of the industrial process. The PLC may be configured to execute the edge application such that the edge workload is performed locally at the PLC during performance of the industrial process.

In some examples, the technology disclosed herein provides a method for aggregating edge workloads of an industrial system. The method may include receiving, from an industrial computing device of the industrial system, an edge application, where the edge application may perform an edge workload related to an industrial process of the industrial system. The method may include storing, at a programmable logic controller (PLC) of the industrial system, the edge application locally in a memory of the PLC such that the edge application is isolated from control logic that controls execution of the industrial process. The method may include executing, at the PLC, the edge application such that the edge workload is performed locally at the PLC.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for aggregating edge computing workloads for industrial systems according to some configurations.

FIG. 2 schematically illustrates an example industrial controller of an industrial system according to some configurations.

FIG. 3 illustrates an example layered architecture diagram for an industrial controller according to some configurations.

FIG. 4 illustrates a flowchart of a method for aggregating edge computing workloads for industrial systems according to some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

As noted herein, the technology disclosed herein relates generally to industrial systems, and, more particularly, to aggregating edge computing workloads for industrial systems. While the technology disclosed herein is described with respect to edge computing workload aggregation, and, in some instances, edge computing workload aggregation for industrial systems, the technology disclosed herein may be implemented or applied to other technologies, fields, use cases, industries, etc.

The technology disclosed herein is related to systems and methods for software defined automation (SDA), and more specifically, to SDA related to a programmable logic controller (PLC).

For instance, the technology disclosed herein involves the hosting of multiple services, acting as a coordinated industrial control workload, on spare compute of a PLC device while leveraging virtualization and safety features of the environments. The benefits of hosting workload services adjacent to the PLC may include reducing communications latency, avoiding network congestion from the communication between the services, and avoiding the expenditure on separate compute platforms that are typically used for PLC services.

Currently, industrial automation workloads (e.g., services or entities that cooperate to perform an industrial automation function) that integrate with PLC applications are hosted on multiple compute platforms or devices, which may include an Industrial PC (IPC) and PLC. The PLC hosts logic authored in, e.g., IEC 61131-3 languages and the IPC hosts services authored in traditional (or general-purpose) programming languages. Using multiple devices for hosting elements of an industrial automation workload (e.g., an industrial process) increases the complexity, latency between components, and the network traffic to facilitate the communications between services residing on the devices.

As SDA enables a wider variety of computing platforms to be utilized compared to traditional dedicated purpose built automation hardware. For example, commercial off-the-shelf hardware may include spare computing resources on some of the hardware platforms being used for a PLC with the SDA. Such spare computing resources of SDA may be leveraged to host applications traditionally hosted elsewhere (e.g., edge applications). The aggregation of edge applications and the control application on the same PLC may reduce hardware investment, alleviate industrial network traffic, and reduce the latency to interact with such edge applications.

The edge applications may include computing workloads of an end-user, such as, e.g., motion, vision, data acquisition, human-machine interface (HMI), historian, analytics, artificial intelligence (AI) inference and machine learning, predictive modeling, and autonomous mobile robot (AMR) applications, which may typically reside on edge or supplemental computing devices (e.g., industrial PCs). In some examples, an application may be comprised of one or more workloads, processes, or services that provide capabilities across one or more other applications. With the technology disclosed herein, edge applications may be executed on spare computing resources of the PLC that also hosts the control application (or logic).

In some specific configurations, safety and real-time critical operations may be isolated from edge applications on the PLC. For example, the edge applications may be sandboxed in a guest operating system (OS) or in containers. A safety hypervisor and safety certified (OS) may be used to host the safety and real-time critical operations, which are isolated from the edge applications that reside on a non-safety certified guest OS. In some instances, safety certified edge workloads may also run by leveraging the safety hypervisor.

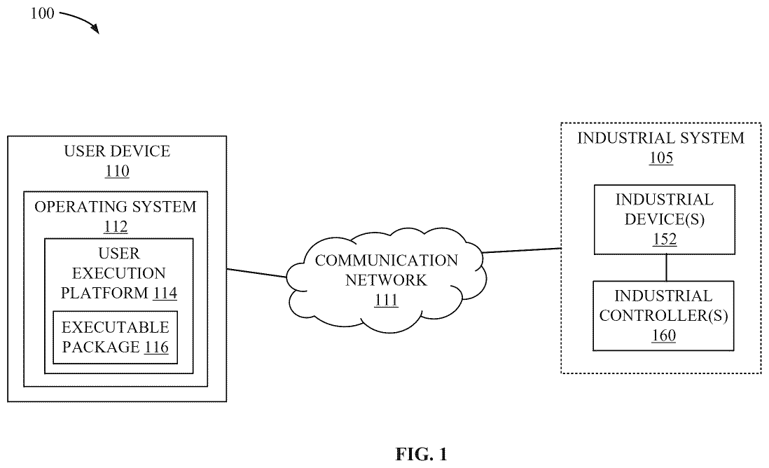

FIG. 1 schematically illustrates an example system 100 for aggregating edge computing workloads for industrial systems according to some configurations. In the illustrated example, the system 100 may include an industrial system 105 and a user device 110. In some configurations, the system 100 includes fewer, additional, or different components in different configurations than illustrated in FIG. 1. As one example, the system 100 may include multiple industrial systems 105, multiple user devices 110, or a combination thereof. As another example, one or more components of the system 100 may be combined into a single device. Alternatively, or in addition, in some configurations, the user device 110 may be included as part of the industrial system 105 (e.g., as a component of the industrial system 105).

The industrial system 105 and the user device 110 may communicate over one or more wired or wireless communication networks 111. Portions of the communication networks 111 may be implemented using a wide area network, such as the Internet, a local area network, such as BLUETOOTH® or WI-FI®, and combinations or derivatives thereof. Alternatively, or in addition, in some configurations, components of the system 100 may communicate directly as compared to through the communication network 111. Also, in some configurations, the components of the system 100 may communicate through one or more intermediary devices not illustrated in FIG. 1.

The user device 110 may also include a computing device, such as a desktop computer, a laptop computer, a tablet computer, a terminal, a smart telephone, a smart television, a smart wearable, or another suitable computing device that interfaces with a user. In some examples, the user device 110 may be included as a component of the industrial system 105, such as, e.g., an HMI of the industrial system 105. However, in some configurations, such as the configuration illustrated in FIG. 1, the user device 110 may be separate or remote from the industrial system 105.

In some configurations, the user device 110 may be an industrial personal computer (IPC). An industrial PC is a computing device that is specifically designed or otherwise configurated for user in industrial environments (e.g., harsh or rugged environments relative to a traditional office setting). For instance, industrial PCs may be specifically designed for continuous operation (e.g., 24/7), extreme or severe environmental conditions (e.g., temperatures, vibrations, electric noise, dust, moisture, etc.), etc. Such industrial PCs may be configured to facilitate control or operations related to an industrial process of the industrial system 105. For example, an industrial PC may perform operations or functionality related to factory automation, machine vision systems, robotics control, data logging or monitoring, etc.

As illustrated in FIG. 1, the user device 110 may include an operating system (OS) 112. The OS 112 may include a user execution platform 114. The user execution platform 114 may be used to create an executable package 116. The OS 112 can include any suitable types of processing circuitry (e.g., one or more central processing units (CPUs), one or more graphics processing units (GPUs), one or more application specific integrated circuits (ASICs), one or more field-programmable gate arrays (FPGAs), etc.) with any suitable configuration of processing cores. In some examples, the user device 110 may further include any suitable types of memory (e.g., volatile, non-volatile, random-access memory (RAM), read-only memory (ROM), electrically erasable programmable read-only memory (EEPROM), etc.).

In some examples, the user execution platform 114 may provide a user with a configurable environment for software development. For example, the user execution platform 114 may include grouped project folders, configurable settings, extensions, or the like, that allow a user to develop workloads. In some examples, the user execution platform 114 may allow a user to create the executable package 116 for a given workload. For example, the executable package 116 can include a docker image containing code, libraries, variables, etc. for running a corresponding workload. In some examples, the workload of the executable package 116 may define an application to be run with respect to the industrial system 105. In some instances, the application may be an edge application that performs an edge workload related to an industrial process of the industrial system 105. For example, the application (or edge application) may include a motion application, a vision application, a human-machine interface (HMI) application, a data gateway, a webserver, a historian application, a predictive modeling application, or the like.

Although not illustrated in FIG. 1, the user device 110 may include similar components as the industrial controller 160, such as electronic processor (e.g., a microprocessor, an ASIC, or another suitable electronic device), a memory (e.g., a non-transitory, computer-readable storage medium), a communication interface, such as a transceiver, for communicating over the communication network 111 and, optionally, one or more additional communication networks or connections, and one or more human machine interfaces. For example, to communicate with the industrial system 105 (or one or more industrial devices 152 or industrial controllers 160 thereof), the user device 110 may store a browser application or a dedicated software application executable by an electronic processor. In some configurations, the user device 110 includes additional, fewer, or different components than the industrial controller 160. As noted herein, the functionality (or a portion thereof) described herein as being performed by the user device 110 may be performed by another device of the system 100, distributed among multiple devices of the system 100, combined with another component of the system 100, or a combination thereof. For example, in some configurations, the functionality (or a portion thereof) described as being performed by the user device 110 may be performed by the industrial device(s) 152, the industrial controller(s) 160, another component of the system 100 or industrial system 105, or a combination thereof.

The industrial system 105 may be a manufacturing system, such as, e.g., an industrial automation system or the like. The industrial system 105 may be associated with (or located at) a facility or site. In some configurations, a facility or site may include multiple industrial systems 105 (e.g., a first industrial system, a second industrial system, a third industrial system, etc.). Accordingly, in some configurations, the industrial system 105 may be implemented at a facility. Alternatively, or in addition, in some configurations, the system 100 may include a first industrial system located at a first facility and a second industrial system located as a second facility different from the first facility. The industrial system 105 may be configured to perform one or more industrial processes, manufacturing processes, production processes, automation processes, or the like. In some configurations, the industrial system 105 may perform a production method that produces goods or products. As one example, the industrial system 105 may perform a vehicle manufacturing process to assemble or produce a vehicle (or various components thereof). As another example, the industrial system 105 may perform a food manufacturing process for making a food product. As yet another example, the industrial system 105 may perform a pharmaceutical manufacturing process for producing pharmaceuticals.

As such, in some configurations, the industrial system 105 can be used to execute or automate manufacturing processes in industries such as, e.g., aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others.

In the illustrated example, the industrial system 105 may include one or more industrial devices 152 (referred to herein collectively as “the industrial devices 152” and individually as “the industrial device 152”). The industrial device(s) 152 may be a physical piece of equipment included in the industrial system 105. For example, an industrial device 152 may include a pump, a press, a conveyor, a valve, a switch, a motor, a motion device, a sensor, a server, a database, a human-machine interface (“HMI”), another piece of equipment that may be used in connection with an associated industrial process or application of the industrial system 105, or the like.

As illustrated in FIG. 1, in some configurations, the industrial system 105 may include one or more industrial controllers 160 (referred to herein collectively as “the industrial controllers 160” and individually as “the industrial controller 160”). The industrial controller 160 may be a programmable logic controller (PLC). In some specific examples, the industrial controller 160 may be a software defined automation (SDA) PLC (e.g., a PLC configured to implement or otherwise facilitate functions or functionality related to SDA). As described herein, the industrial controller 160 may facilitate (or otherwise control) performance of an industrial process (or portion(s) thereof) with respect to the industrial system 105.

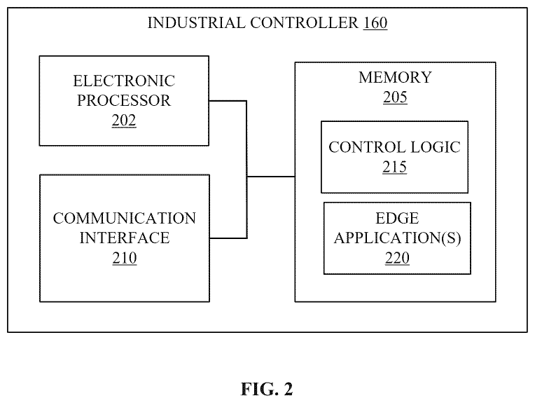

FIG. 2 illustrates an example industrial controller 162 of the industrial system 105. As illustrated in FIG. 2, the industrial controller 160 may include an electronic processor 202, a memory 205, and a communication interface 210. The electronic processor 202, the memory 205, and the communication interface 210 may communicate wirelessly, over one or more communication lines or buses, or a combination thereof. The industrial controller 160 may include additional, different, or fewer components than those illustrated in FIG. 2 in various configurations. The industrial controller 160 may also perform additional or different functionality other than the functionality described herein.

The communication interface 210 may include a transceiver that communicates with the industrial system 105 (e.g., the industrial device(s) 152 of the industrial system 105, another component or device of the industrial system 105, etc.), the user device 110, or a combination thereof over the communication network 111 and, optionally, one or more other communication networks or connections. In some configurations, the communication interface 210 enables the industrial controller 160 to communicate with the industrial system 105 (e.g., the industrial device(s) 152 of the industrial system 105), the user device 110, or a combination thereof over one or more wired or wireless connections. The electronic processor 202 may include a microprocessor, an application-specific integrated circuit (“ASIC”), a graphics processing unit (GPU), or another suitable electronic device for processing data, and the memory 205 includes a non-transitory, computer-readable storage medium. The electronic processor 202 is configured to retrieve instructions and data from the memory 205 and execute the instructions.

For example, as illustrated in FIG. 2, the memory 205 may include control logic 215. The control logic 215 may be a control program of the industrial controller 160. In some cases, the control logic 215 may control (or otherwise facilitate) a real-time (or near real-time) operation of the industrial system 105 (or industrial process(es) performed thereby). For instance, the control logic 215 may include one or more executable instructions that implement (or otherwise) control implementation or execution of an industrial process (or portion(s) thereof) of the industrial system 105. In some instances, the control logic 215 may be in a programming language specific for industrial controls or PLCs (e.g., a PLC programming language), such as, e.g., ladder logic, function block diagram, structured text, sequential function chart, etc.

In some examples, the control logic 215 may control performance of various functions (or logic) by one or more of the industrial devices 152 (e.g., drive industrial assets, devices, and sensors in an industrial process of the industrial system 105). In some instances, the control logic 215 may relate to, e.g., a monitoring process, an automation process, a data acquisition process, a sequence management process, an error detection process, a fault detection process, etc. For example, the control logic 215 may include one or more operations related to the industrial device(s) 152, such as, e.g., one or more switching operations, load isolation operations, signal routing operations, torque control operations, acceleration control operations, deceleration control operations, or the like. In some instances, execution of the control logic 215 (or portion(s) thereof) may involve (or otherwise include) one or more logic functions. For example, the electronic processor 202 may perform (or otherwise execute) a logic function to execute the control logic 215 (or portion(s) thereof). As one example, the control logic 215 may include a routine involving a sequence of logic to be executed as a block (e.g., a sequence of one or more logic functions). Following this example, to execute the control logic 215, the electronic processor 202 may execute the routine by executing the sequence of logic of that routine.

As illustrated in FIG. 2, the control logic 215 is included in the memory 205 of the industrial controller 160. However, in some configurations, the control logic 215 (or portion(s) thereof), may be included in a separate device accessible by the industrial controller 160 (included in the industrial controller 160 or external to the industrial controller 160).

In the illustrated example of FIG. 2, in some configurations, the memory 205 may include one or more edge applications 220 (referred to herein collectively as “the edge applications 220” and individually as “the edge application 220”). As described herein, the edge application(s) 220 may include (or otherwise involve) computing workloads of an end-user (also referred to herein as “edge workloads”). For instance, the edge application(s) 220 may include workloads related to (or otherwise involving), e.g., motion, vision, data acquisition, human-machine interface (HMI), historian, analytics, artificial intelligence (AI) inference and machine learning, predictive modeling, autonomous mobile robot (AMR) applications, etc. As such, in some instances, the edge application(s) 220 may be an analytics application, a historian application, a data acquisition application, a motion application, a HMI application, etc. As described herein, in traditional implementations, such edge applications typically reside on edge or supplemental computing devices, such as, e.g., the user device 110, an industrial PC, another component or device of the industrial system 105, etc. In some instances, the edge application(s) 225 may be in a general-purpose programming language (e.g., a programming language that is not specific to industrial controllers or PLCs), such as, e.g., python, C, C++, Java, etc. As such, in some instances, the control logic 215 may be in a first programming language while the edge application(s) 220 may be in a second programming language different than the first programming language.

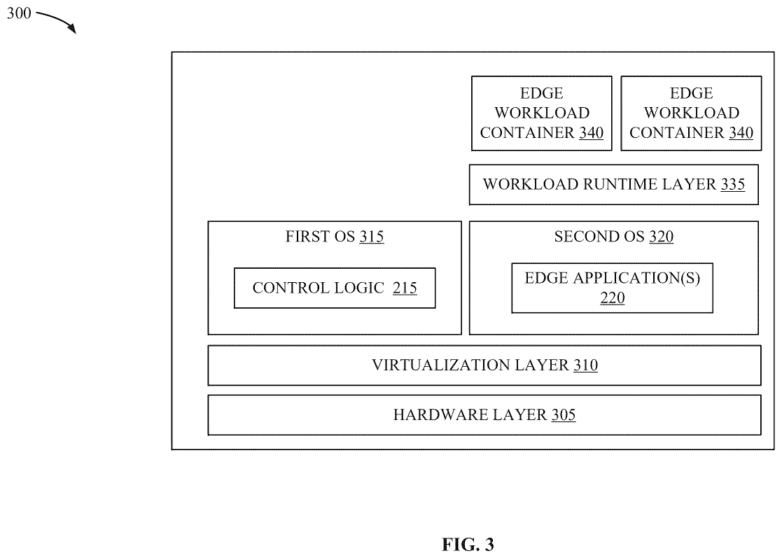

FIG. 3 is a layered architecture diagram 300 for the industrial controller 160 according to some configurations. The diagram 300 of FIG. 3 may be an example of a Type-1 Hypervisor Architecture for the industrial controller 160. As illustrated in FIG. 3, the diagram 300 may include a hardware layer 305. The hardware layer 305 may represent the physical elements or components of the industrial controller 160, such as, e.g., the electronic processor 202, the memory 205, etc. The diagram 300 may include a virtualization layer 310. In some configurations, the virtualization layer 310 may sit on top of the hardware layer 305 (e.g., directly on top of the hardware layer 305). In some examples, the virtualization layer 310 may be a hypervisor. In some specific examples, the virtualization layer 310 may be a Type-1 Hypervisor.

As illustrated in FIG. 3, the diagram 300 may further include a first OS 315 and a second OS 320. In some examples, the first OS 315, the second OS 320, or a combination thereof may be distinct or separate operating systems. For example, the first OS may be a host OS of an industrial device or a guest OS of an industrial device. The first OS 315 and the second OS 320 may be a guest OS of a host device (e.g., an industrial device 152),. Further, in some cases, the first OS 315, the second OS 320, or a combination thereof may be implemented through a corresponding virtual machine (e.g., a first virtual machine may run the first OS 315, and a second virtual machine may run the second OS 320). In some examples, the first OS 315 and the second OS 320 may be isolated. In some instances, the first OS 315, the second OS 320, or a combination thereof may provide (or otherwise host) virtual (or virtualized) environments. In the example of FIG. 3, the first OS 315 may include the control logic 215 and the second OS 320 may include the edge application(s) 220.

In some instances, the first OS 315 may be a certified OS of the industrial controller 160 and the second OS 320 may be an uncertified OS of the industrial controller 160. As one specific example, the first OS 315 may be a safety certified OS used to host safety or real-time operations (e.g., the control logic 215), which may be isolated from the edge application(s) (e.g., the edge application(s) 220) that may reside on a non-safety certified guest OS, such as, e.g., the second OS 320.

In some examples, the first OS 315 may be implemented via a private portion (or private memory portion), a native portion (or native memory portion), or a premier zone (or premier zone of memory and compute resources) of the industrial controller 160. As used herein, a private portion or a native portion of the industrial controller 160 may represent (or otherwise include) a portion of memory that is allocated for a particular task or function (e.g., communication modules, motion control, safety functions, diagnostics, etc.). In some instances, a private memory portion or a native memory portion of the industrial controller 160 may be isolated, hidden, or system-reserved memory for internal operations of the industrial controller 160. For example, the private memory portion or a native memory portion of the industrial controller 160 may not be user-programmable or otherwise hidden from a user's application logic. Accordingly, in some configurations, the control logic 215 may be stored in a native portion of the memory 205 such that, when executed, the control logic 215 is natively executed by the industrial controller 160. Further, in some examples, the private (or native) portion of the industrial controller 160 may include one or more restrictions on workload types that are supported (e.g., only real-time operating system workloads).

In some examples, the first OS 315 or second OS 320 may be implemented via an isolated portion, or an isolated memory portion with container runtime for access by a third party, of the industrial controller 160. As used herein, an open portion (or open memory portion) of the industrial controller 160 may represent (or otherwise include) a portion of memory that is accessible for user programs or application logic (e.g., the edge application(s) 220). In some specific examples, the second OS 320 may provide (or otherwise host) a virtual (or virtualized) environment. Further, in some examples, the open portion of the industrial controller 160 may be a virtual environment on the industrial controller 160 configured to run one or more types of workloads (e.g., non-real-time operating system workloads).

As further illustrated in the example of FIG. 3, the diagram 300 may include a container runtime layer 335. In some instances, the container runtime layer 335 may support one or more edge workload containers 340 (e.g., containers hosting or facilitating edge workloads, such as, e.g., the edge application(s) 220). As illustrated in FIG. 3, the diagram may further include a workload runtime layer 345 below the first OS 315 and the second OS 320. In some configurations, the workload runtime layer 345 (e.g., including the corresponding edge workload containers 340) may be implemented on top of the virtualization layer 310. Alternatively, or in addition, in some instances, the workload runtime layer 345 (e.g., including the corresponding edge workload containers 340) may be implemented on top of the second OS 320. In some examples, the workload runtime layer 345 may enable the edge workload container(s) 340 or other forms of edge workloads) to interact with other workloads in the native OS, while still maintaining isolation.

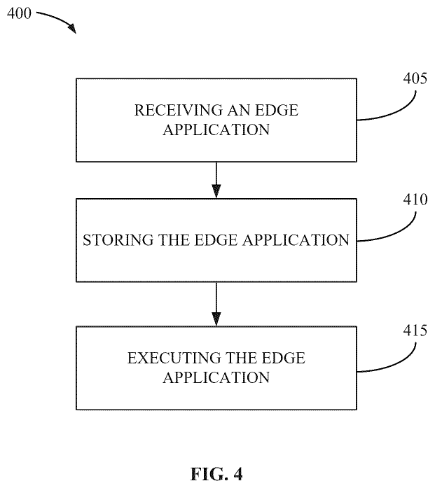

FIG. 4 is a flowchart illustrating a method 400 for aggregating edge computing workloads for industrial systems according to some configurations. The method 400 is described as being performed by industrial controller 160 (e.g., the electronic processor 202). However, as noted herein, the functionality described with respect to the method 400 may be performed by other devices, such as the industrial device(s) 152, the user device 110, another industrial device, another component included in the industrial system 105, or a combination thereof, distributed among a plurality of devices, such as a plurality of servers included in a cloud service, or a combination thereof. As described below, a particular implementation can omit some or all illustrated features/steps, may be implemented in some embodiments in a different order, and may not involve some illustrated features to implement all embodiments.

As illustrated in FIG. 4, the method 400 may include receiving an edge application (e.g., the edge application(s) 220) (at block 405). As described herein, in some configurations, the edge application(s) 220 may, when executed, perform an edge workload related to an industrial process of the industrial system 105. For instance, in some examples, the edge application(s) 220 may include an analytics application or workload, a historian application or workload, a data acquisition application or workload, a motion application or workload, a human-machine interface (HMI) application or workload, etc. In some configurations, the electronic processor 202 may receive the edge application(s) 220 from a remote device (e.g., a remote edge device). As one example, the electronic processor 202 may receive the edge application(s) 220 from the user device 110 over the communication network 111 (e.g., as an executable package 116).

The electronic processor 202 may store the edge application(s) 220 (at block 410). As described in greater detail herein, in some configurations, the electronic processor 202 may store the edge application(s) 220 in a memory local to the industrial controller 160, such as, e.g., the memory 205. In some configurations, the electronic processor 202 may store the edge application(s) 220 such that the edge application(s) 220 are isolated from the control logic 215. For example, the electronic processor 202 may store the edge application(s) 220 in the memory 205 (e.g., the edge workload containers 340), a guest OS (e.g., the second OS 320), an open portion of the memory 205, etc. As one specific example, the electronic processor 202 may store the edge application(s) 220 within a container of the memory 205 (e.g., the edge workload containers 340) such that the electronic processor 202 may execute the edge application(s) 220 within a container of the memory 205. As another specific example, the electronic processor 202 may store the edge application(s) 220 within a virtualized environment of a container of the memory 205 such that the electronic processor 202 may execute the edge application(s) 220 within a virtualized environment of the container of the memory 205. As such, in some configurations, the control logic 215 may be hosted within a certified OS (e.g., the first OS 315) of the industrial controller 160 and the edge application(s) 220 may be hosted within an uncertified OS (e.g., the second OS 320) of the industrial controller 160. In further examples, a certified hypervisor may further be utilized by the industrial controller 160, in combination with the certified OS.

The electronic processor 202 may execute the edge application(s) 220 (at block 415). In some instances, the electronic processor 202 may execute the edge application(s) 220 such that the edge workload associated with the edge application(s) 220 is performed locally at the industrial controller 160. In some examples, the electronic processor 202 may execute the edge application(s) 220 during performance of an industrial process of the industrial system 105. As such, in some configurations, the electronic processor 202 may execute the control logic 215 (e.g., in order to control performance of the industrial process). In some specific configurations, the electronic processor 202 may simultaneously execute the control logic 215 and the edge application(s) 220, such that at least a portion of the execution of the control logic 215 and at least a portion of the execution of the edge application(s) 220 temporally overlap.

As described herein, in some configurations, the electronic processor 202 may execute the control logic 215, the edge application(s) 220, or a combination thereof such that the control logic 215 and the edge application(s) 220 are isolated during execution. For instance, as one specific example, the electronic processor 202 may execute the control logic 215 within a private or native memory portion (e.g., the first OS 315) and may execute the edge application(s) 220 within an open memory portion (e.g., the second OS 320), a container (e.g., the edge workload containers 340), or a combination thereof.

As noted herein, in some instances, the control logic 215 and the edge application(s) 220 may be in different programming languages. However, using the technology disclosed herein, the electronic processor 202 may locally execute the edge application(s) 220 without converting the edge application(s) 220 into a compatible PLC programming language (e.g., ladder logic, function block diagram, structured text, etc.). For example, in some instances, the edge application(s) 220 may be executed within a virtualized container environment that is compatible with a general-purpose programming language (e.g., python, C, C++, etc.).

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. An industrial controller of an industrial system, the industrial controller comprising:
a memory storing:
control logic that controls performance of an industrial process of the industrial system, and
an edge application that performs a function related to the industrial system; and
a processor coupled to the memory, the processor configured to:
execute the control logic to control performance of the industrial process of the industrial system; and
execute the edge application such that the function is performed locally at the industrial controller.

2. The industrial controller of claim 1, wherein the control logic controls a real-time operation of the industrial system.

3. The industrial controller of claim 1, wherein the control logic is isolated from the edge application.

4. The industrial controller of claim 1, wherein the control logic is hosted within a certified operating system (OS) of the industrial controller and the edge application is hosted within an uncertified OS of the industrial controller.

5. The industrial controller of claim 1, wherein the processor is configured to execute the edge application within a portion of the memory.

6. The industrial controller of claim 5, wherein the processor is configured to execute the edge application within a virtualized environment of a container.

7. The industrial controller of claim 1, wherein the control logic is stored in a native portion of the memory such that, when executed, the control logic is natively executed by the industrial controller.

8. The industrial controller of claim 1, wherein the industrial controller is a programmable logic controller of the industrial system.

9. A system for aggregating edge workloads of an industrial system, comprising:
a programmable logic controller (PLC) of the industrial system, the PLC configured to:
receive, from a remote device, an edge application, wherein the edge application is to perform an edge workload related to an industrial process of the industrial system;
store the edge application in a memory local to the PLC, wherein the edge application is isolated from control logic that controls execution of the industrial process;
execute the control logic in order to control performance of the industrial process; and
execute the edge application such that the edge workload is performed locally at the PLC during performance of the industrial process.

10. The system of claim 9, wherein the edge application includes at least one of: an analytics application, a historian application, a data acquisition application, a communication application, a motion application, or a human-machine interface (HMI) application.

11. The system of claim 9, wherein the PLC is configured to execute the edge application within a virtualized container environment of the PLC.

12. The system of claim 9, wherein the control logic is in a first programming language and the edge application is in a second programming language different from the first programming language.

13. The system of claim 9, wherein the PLC is configured to execute the edge application without converting the edge application into a compatible PLC programming language.

14. The system of claim 9, wherein the remote device is an industrial computing device included in the industrial system.

15. A method for aggregating edge workloads of an industrial system, the method comprising:
receiving, from an industrial computing device of the industrial system, an edge application, wherein the edge application is to perform an edge workload related to an industrial process of the industrial system;
storing, at a programmable logic controller (PLC) of the industrial system, the edge application locally in a memory of the PLC such that the edge application is isolated from control logic that controls execution of the industrial process; and
executing, at the PLC, the edge application such that the edge workload is performed locally at the PLC.

16. The method of claim 15, further comprising:
executing, at the PLC, the control logic to control performance of the industrial process.

17. The method of claim 15, wherein executing, at the PLC, the edge application includes executing the edge application during execution of the control logic.

18. The method of claim 15, further comprising:
receiving a second edge application, wherein the second edge application is to perform a second edge workload related to the industrial process of the industrial system;
storing, at the PLC, the second edge application locally in the memory of the PLC, wherein the second edge application is isolated from the control logic; and
executing, at the PLC, the second edge application such that the second edge workload is performed locally at the PLC.

19. The method of claim 15, wherein storing the edge application locally in the memory of the PLC includes storing the edge application within an open portion of the memory, wherein the control logic is stored within a private portion of the memory.

20. The method of claim 15, wherein the edge application is further stored in a private memory hidden from other workloads of the industrial system.
